(19) United States
(12) Patent Application Publication
(10) Pub. No.: US 2015/0036214 A1
(43) Pub. Date: Feb. 5, 2015

(54) SURFACES WITH A GLASS APPEARANCE AT MOBILE CONTROLS FOR MOTOR VEHICLES

(71) Applicant: Hella KGaA Hueck & Co., Lippstadt (DE)

(72) Inventor: Tobias Heine, Lippstadt (DE)

(21) Appl. No.: 14/449,558

(22) Filed: Aug. 1, 2014

(30) Foreign Application Priority Data
Aug. 2, 2013 (DE) 102013108341.2

(51) Int. Cl. G02B 27/22; G02B 27/14

(52) U.S. Cl. CPC G02B 27/2278; G02B 27/148
USPC 359/479

(57) ABSTRACT

A transparent component comprising glass or a glass-like material with an exterior surface. The exterior surface shows a reflection, which differs from the reflection of a background surface. The exterior surface as well as the background surface are partially or entirely reflective of incident light like a mirror and by the distance of the two surfaces from each other the reflection at the surfaces is reflected differently such that the reflection at the exterior surface appears at a different point than on the background surface. Thereby, a depth effect is generated.

### CROSS REFERENCE

This application claims priority to German Patent Application No. 10 2013 108341.2, filed Aug. 2, 2013, which is hereby incorporated by reference.

### FIELD OF THE TECHNOLOGY

The invention relates to a transparent component comprising glass or a glass-like material with a superficial glass appearance, particularly for mobile controls for motor vehicles.

### BACKGROUND

Prior art limits a distinct variation of the appearance and haptic value appeal at mobile controls for motor vehicles, such as radio keys, to the application of colors and surface structures only and to the materials plastics and metals. Simple, hard to differentiate upgrades of buttons and housings, as well as housing parts are the result of a limited selection of materials. A limitation of the design options results also from the restriction to the use of conventional materials, such as black or colored plastics as well as metallic parts for radio keys, particularly regarding its buttons and decorative elements. Any upgrade is here impossible or largely restricted by the limited material selection and/or material suitability. Options are required to allow realizing the above-described features and effects.

### SUMMARY OF THE INVENTION

The objective of the present invention is to overcome the disadvantages of prior art and to realize mobile controls for motor vehicles with a 2D and 3D optic for targeted depth effects.

In order to attain this objective a transparent component comprising glass or a glass-like material is provided with an exterior surface, with the exterior surface showing a distinct luster and/or a distinct reflection, which differs from the reflection of the background surface (interior level of the transparent component), with the exterior surface as well as the background surface partially or entirely reflecting incident light like a mirror and by the distance of the two surfaces from each other the reflections at the surfaces are returned differently so that the luster and/or the reflection appears at the exterior surface at a different point than on the background surface, whereby a depth effect is generated.

The particular advantage of the invention comprises that by glass applications and/or by the use of glass or other transparent materials or transparent coatings for, glass imitation, depth effects are realized in a targeted fashion at mobile controls for motor vehicles.

The transparent component preferably comprises a diffraction index different from that of the environmental medium and/or the air, resulting in a targeted or diffuse reflection at the respective boundaries depending on the surface roughness.

The transfer of the impression of the glass appearance is achieved by the use of 3D and depth effects of symbols, pictograms, letters, and other markings. Novel design options arise from this for upgrading mobile controls for motor vehicles by using novel materials and material appearances, which differ from the impressions previously known from prior art.

The glass-like material is preferably an aluminum silicate glass. Here, the use of transparent substitute materials is especially preferred, particularly transparent substitute materials, for example plastics, such as PC, PMMA, resin, etc.

According to a further development of the invention the background surface of the transparent component shows coloration or pigmentation. This way, appropriate colorations in the transparent component can be defined in a controlled fashion.

According to a further development of the invention the exterior surface of the transparent component shows coloration or pigmentation. This way, colorations can also be generated in the transparent component.

A dyed transparent, preferably translucent, component achieves partial light permeability through the coloration. By mixing the transparent component with pigments or particles and adjusting the mixing ratio, preferably a defined translucency and/or light diffusion can be additionally achieved within the component.

According to a further development of the invention the transparent component comprises a single or multi-layered laminar structure showing transparent layers. A single or multi-layered laminar structure may show colored or also transparent layers, which can be printed, laminated, lased, etched, or enameled. This way a multi-layered depth effect can be generated with symbols, pictograms, letters, and other markings.

Preferably the laminar structure comprises transparent layers, which differ from each other by consisting of different materials with different diffraction indices and/or being geometrically embodied such that they show different light diffraction features from each other.

According to a further development of the invention a design is provided with two or more components, with at least one transparent component being produced in a two or more component injection molding process including additional components, such as symbols, pictograms, letters, and other markings, a relief base or decorative parts, or produced separately and subsequently connected to each other by plug-in, lamination, friction welding, clips, lasers, and/or by ultrasound.

According to a further development of the invention bevels, radii, or other recesses are provided at the edge region of the transparent component. This way spatial effects, depth and structural effects caused by incident light can be further improved.

According to a further development of the invention the transparent component is embodied concavely or convexly as an optic lens. Preferably the transparent component is embodied as an elevated structure, which may project from the surface of the component partially or entirely. This way spatial effects, depth and structural effects can be implemented even better.

Preferably a relief structure is provided, which is covered, enclosed, or framed with at least one transparent layer, which structure is plastically elevated and/or recessed, different from the base of the relief, which represents the background and/or underground of the relief structure.

Particularly preferably, the relief structure together with the relief base can be a functional part of a button, a control, or a decorative part. Here the relief structure can partially or entirely be treated by coating or printing, laminating, lasing, etching, or enameling and can be produced per se and/or together with the relief base showing one component or several components.

According to a further development of the invention the background surface of the transparent component is further partially offset from the surrounding surface. Further, the background surface of the transparent component is embodied as a surface of a substrate or a housing part.

According to a further development of the invention, in addition to illumination by incident light from outside the transparent component, here a background illumination of the transparent component is possible as well. This way, light can additionally be generated behind the transparent component in order to generate the depth effect at twilight or darkness.

In order to attain the objective, further a radio key for motor vehicles is provided, comprising at least one transparent component, with the transparent component representing a button, a control, or a decorative part. The operating elements can here be integrated in the radio key.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 is an illustration of a radio key with transparent controls according to the invention.

FIG. 2 is a cross-section through a detail of the radio key of FIG. 1

FIG. 3 is a cross-section through an alternative embodiment of FIG. 2

FIG. 4 is a schematic design of the transparent component of FIG. 1

FIG. 5 is an alternative schematic design of the transparent component,

FIG. 6 is another alternative schematic design of the transparent component,

FIG. 7 is another alternative schematic design of the transparent component, and

FIG. 8 is another alternative schematic design of the transparent component.

### DETAILED DESCRIPTION OF THE DRAWINGS

The “glass look” effect appears on components with a transparent layer with a visible layer thickness. This means, the exterior surface of the transparent component is visibly distinguishable from the rear surface of the transparent component (in the context given also called an interior surface or a background surface). This is explained in greater detail based on the figures:

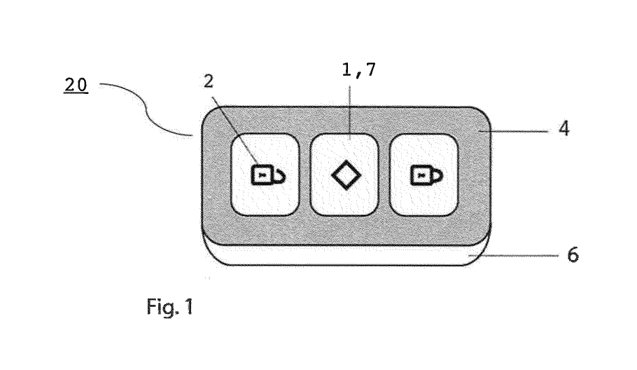

FIG. 1 shows an illustration of a radio key with transparent controls according to the invention. The radio key 20 comprises, in addition to its housing part 4, controls/buttons 1, 7, and decorative parts 6. The controls are embodied as transparent component 1 or as a component in the laminar design 7.

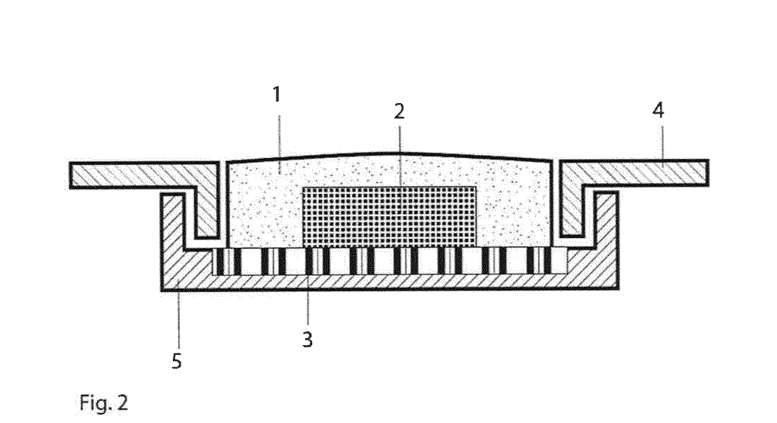

FIG. 2 shows a cross-section through a detail of the radio key of FIG. 1. A transparent component 1, another component 2, a relief base 3, housing parts of the key 4, and the button functions geometry 5 are shown in the cross-section. The other component 2 represents, for example, a pictogram, a lettering, or a symbol. The component 2 is surrounded by the transparent component 1 and the relief base. The component 1 and the additional component 2 are produced, for example, in a two-component injection molding process and are located with the relief base 3 on the button functions geometry 5. The relief base 5 is embodied with several components.

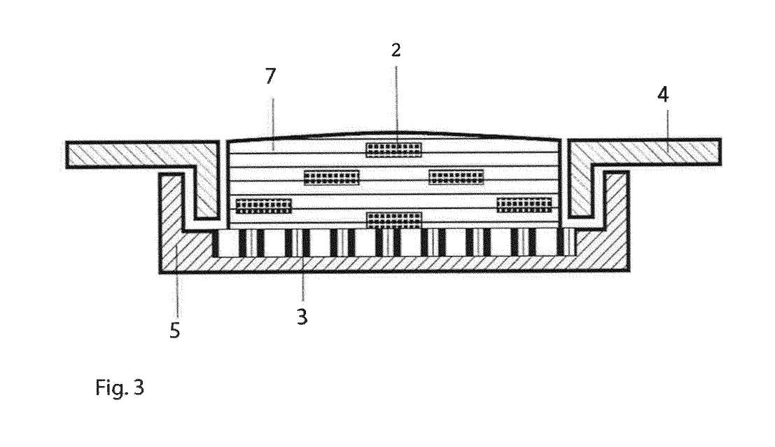

FIG. 3 shows a cross-section through an alternative embodiment of FIG. 2 Several laminar layers 7, a plurality of additional components 2, a relief base 3, housing parts of the key 4, and the button functions geometry 5 are shown in the cross-section. The laminar layers 7 are coated, printed, laminated, lased, etched, or enameled entirely or partially.

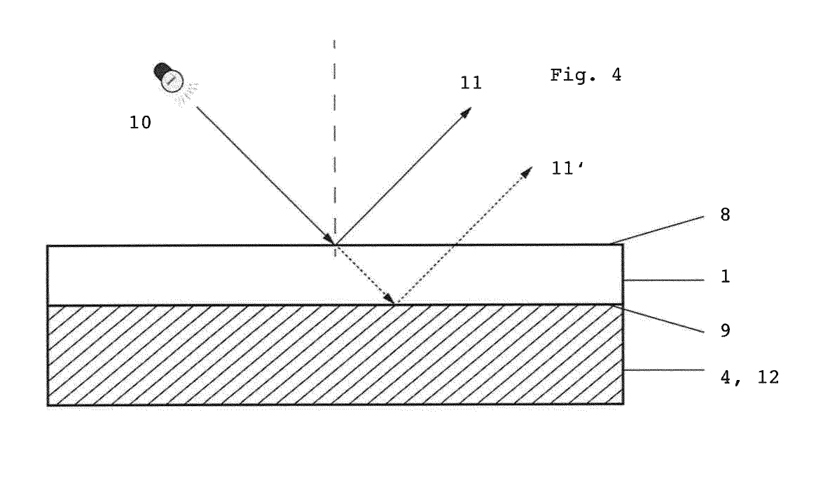

FIG. 4 shows a schematic design of the transparent component of FIG. 1. The design comprises an exterior surface 8 of the transparent component 1, a background surface and/or an internal level 9 of the transparent component 1, and a housing part 4 or a substrate 12. The exterior surface 8 of the transparent component 1 shows a distinct luster, and/or a distinct reflection, which is elevated or differs from the luster and/or the reflection of the background surface or an interior level 9 by the exterior surface 8 as well as the interior level/background surface 9, partially or entirely reflecting incident light 10 like a mirror and due to the distance of the two surfaces from each other it is reflected differently so that the luster and/or the reflection appears on the exterior surface at a different point than on the background surface 9.

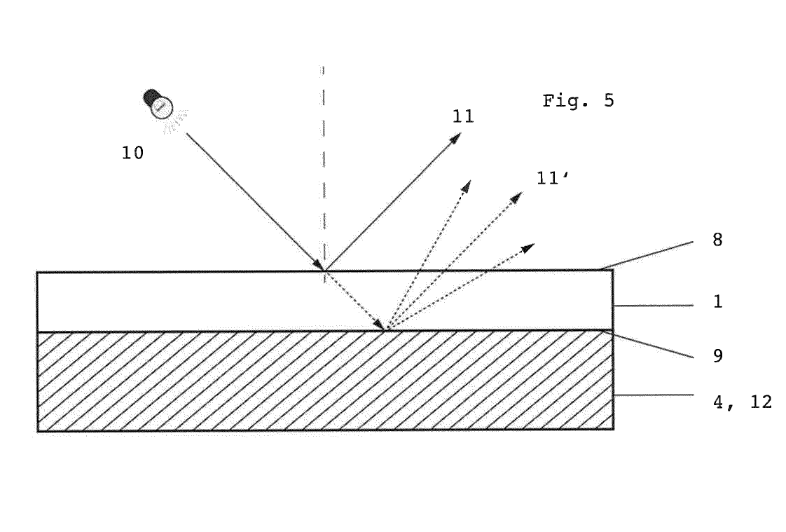

FIG. 5 shows an alternative schematic design of the transparent component. The design is equivalent to the one of FIG. 4, with the difference here that the background surface and/or the interior level 9 showing different roughness or levels of luster. Incident light is reflected with different luster, and/or differently diffused or dispersed from each surface/level (see reflection 11′).

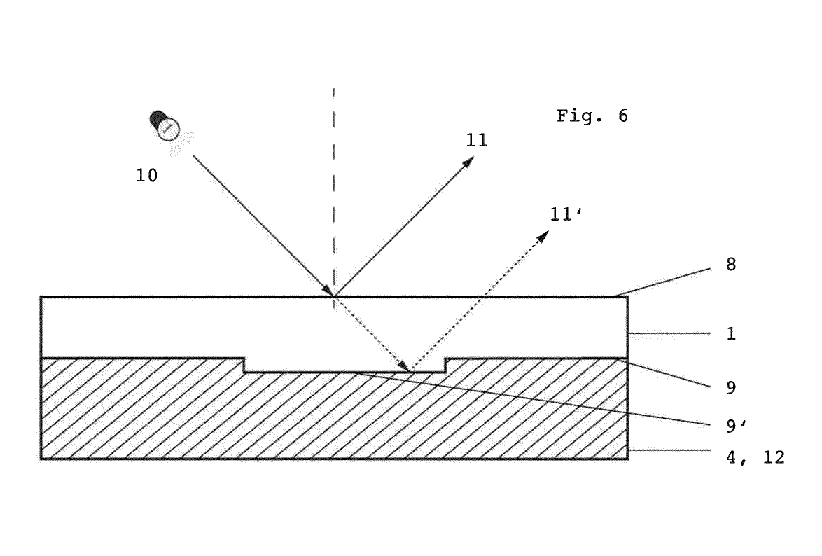

FIG. 6 shows another alternative schematic design of the transparent component. The design is equivalent to the one of FIG. 4, with the difference here that an off-set and/or a step 9′ has been implemented in the background surface and/or the interior level 9.

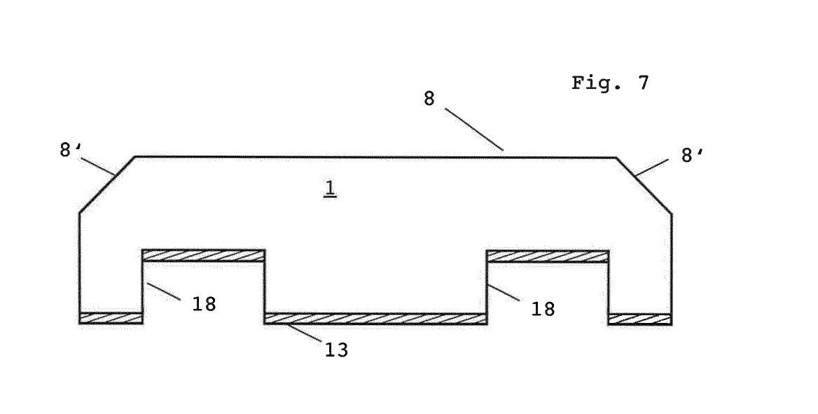

FIG. 7 shows another alternative schematic design of the transparent component. The component 1 shows in the cross-section diagonal sections at both sides, representing bevels 8′. Furthermore, two recesses 18 are provided from the bottom, which influence the geometry of the component 1. In all horizontal areas, a substrate layer 13 is provided at the bottom of the component 1. The transparent component 1 is embodied as a 1-component injection molded part. The surfaces 13 are rendered “opaque” and/or light-impermeable via a coating, or a sprayed, dyed, or printed film.

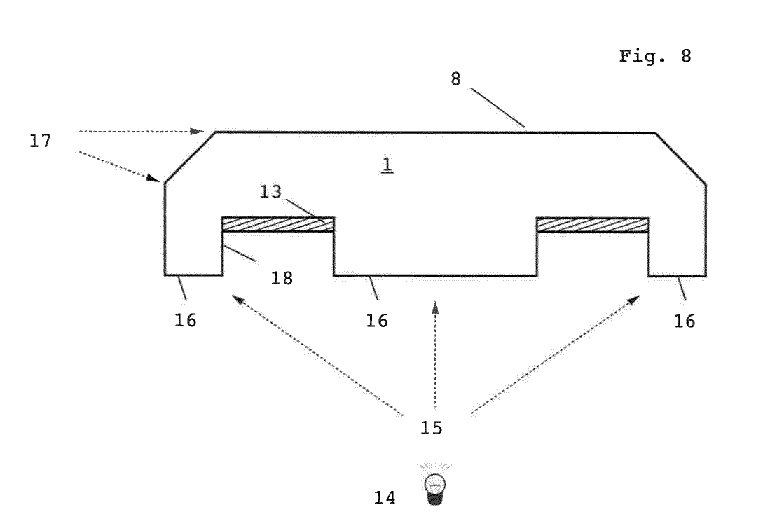

FIG. 8 shows another alternative schematic design of the transparent component. The design is equivalent to the one of FIG. 7, with the difference here that the substrate layer 13 is provided at the horizontal recesses. In the lower sections, at which no substrate layer is applied, partially light-permeable sections 16 are provided. An illuminant 14 serves for illuminating the background of the structure.

The underside is structured in the form of a symbol or pictogram such that it appears elevated or recessed as a three-dimensional figure in the component, the underlying surface 13 is partially rendered “opaque” and/or light-impermeable, for example by a coating or a sprayed, dyed, or printed film, with light-impermeable sections 16 being provided at and additionally at least at one point.

The light-impermeable sections 16 are located behind the edge section and/or behind a symbol.

The illuminant 14 is arranged underneath the transparent component 1 and/or inside the device body such that the transparent component 1 is illuminated at the back by emitting light 15.

The light-permeable section 16 is here designed such that during the transillumination, the light 15 of the illuminant 14 appears as a defined geometric, illuminated figure, e.g., as a symbol, and this way it can be recognized by the observer, e.g., as a bright symbol.

The light-permeable section 16 is embodied such that when illuminant 14 is not active and with non-translucent light it appears as a defined geometric figure, e.g., as a symbol, and this way it can be recognized by the observer.

The light-permeable section 16 thereby allows the light 15 of the illuminant 14 to pass such that this can disperse within the transparent component 1.

Geometric features and structures, such as body edges 17, pigmentation, or three-dimensional or planar elements inside the transparent component 1 and/or its exterior, which are illuminated by the light 15 such that it is refracted here and these geometric features and structures are therefore indirectly illuminated and the light becomes visible for the observer at these areas.

These geometric features and structures are also discernible when the illuminant is not active.

### REFERENCE LIST

1 transparent component
2 symbols, pictograms, lettering, or other markings
3 relief base
4 housing part of a radio key
5 button functions geometry
6 decorative part
7 layer/layer thickness
8 exterior surface of the transparent component
8′ bevels or radii of the transparent component
9 background surface or internal level of the transparent component
9′ off-set in the transparent component
10 incident light
11 reflection of the incident light at the exterior surface
11′ reflection of the incident light at the background surface or interior level of the transparent component
12 substrate
13 “opaque” and/or light-impermeable underlying surface of the transparent component
14 illuminant
15 light of the illuminant
16 partially light-permeable areas
17 body edges of the transparent component
18 recess
20 radio key

1. A transparent component comprising:
glass or a glass-like material with an exterior surface and a background surface, wherein the exterior surface shows a reflection which differs from a reflection of the background surface,
wherein the exterior surface as well as the background surface are partially or entirely reflective of incident light like a mirror, and
wherein a distance of the two surfaces from each other differently returns a reflection at said surfaces such that the reflection on the exterior surface appears at a different point than the reflection of the background surface, thereby generating a depth effect.

2. The transparent component according to claim 1, wherein the exterior surface as well as the background surface show different roughness levels or levels of polish and thus incident light can be reflected with different luster, or differently diffused, or disbursed from each level.

3. The transparent component according to claim 1, wherein the back-ground surface of the transparent component showing coloration or pigmentation.

4. The transparent component according to claim 1, wherein the exterior surface of the transparent component showing coloration or pigmentation.

5. The transparent component according to claim 1, wherein the trans-parent component comprising a single or multi-layered laminar structure of transparent layers.

6. The transparent component according to claim 1, wherein bevels, radii, or other recesses being provided at an edge region of the transparent component.

7. The transparent component according to claim 1, wherein the transparent component being embodied concavely or convexly as an optic lens.

8. The transparent component according to claim 1, wherein the background surface of the transparent component is at least one of: partially offset with regards to depth from the surrounding area, and embodied as a surface of a substrate or a housing part.

9. The transparent component according to claim 1, wherein a back-ground illumination of the transparent component being provided.

10. A radio key for motor vehicles comprising at least one transparent component according to claim 1, wherein the transparent component representing a button, a control, or a decorative part.
